(19) United States
(12) Patent Application Publication
(10) Pub. No.: US 2015/0257374 A1
(43) Pub. Date: Sep. 17, 2015

(54) FISH HOOK SYSTEM

(71) Applicants: PETER J. DREES, PEWAUKEE, WI (US); ANDREW M. SMITH, PEWAUKEE, WI (US); DANIEL L. BURKE, SANFORD, FL (US)

(72) Inventors: PETER J. DREES, PEWAUKEE, WI (US); ANDREW M. SMITH, PEWAUKEE, WI (US); DANIEL L. BURKE, SANFORD, FL (US)

(73) Assignee: DOUBLE CATCH LURES, LLC, PEWAUKEE, WI (US)

(21) Appl. No.: 14/657,425

(22) Filed: Mar. 13, 2015

Related U.S. Application Data
(60) Provisional application No. 61/953,457, filed on Mar. 14, 2014.

(51) Int. Cl. A01K 91/10; A01K 97/11

(52) U.S. Cl. CPC A01K 91/10; A01K 97/11

(57) ABSTRACT

Systems directed to the art of setting a hook in a fish mouth have an activation member assembly removably interfaced with a spring-loaded plunger assembly. A fish hook is attached via fishing lines to both the activation member assembly and the plunger assembly. Pulling the hook releases the plunger assembly from the activation member assembly and pulls the line attached to the plunger assembly, setting the hook in the fish's mouth.

### RELATED APPLICATIONS

This application claims the benefit of co-pending U.S. Provisional Patent Application Ser. No. 61/953,457, filed 14 Mar. 2014, and entitled “Fish Hook System,” which is incorporated herein by reference in its entirety.

### BACKGROUND OF THE INVENTION

Fishing is an activity predicated on patience and timing. When a fish snatches the bait offered on an unassuming hook or takes a bite of an attractive lure, the angler must be ready to set the fishing hook in the mouth of the fish to ensure the capture of the water faring beast, or else embrace the fate of being the losing party in another epic fishing saga. Setting a hook is generally accomplished by pulling back on the fishing rod in a quick jerking motion. If poorly timed, either too early or too late, the fish may escape as the hook has either not yet entered the fish's mouth or the fish has already taken the bait and swam away.

Accordingly, anglers would benefit from a device capable of more consistently setting a hook in a fish's mouth at a more advantageous time.

### SUMMARY OF THE INVENTION

The present invention relates to a hook setting device configured to set a hook in a fish's mouth with more consistency and with a greater rate of success. The present invention comprises an activation member assembly which, when triggered by a fish, will release an arm of a plunger assembly retained under pressure by a spring. The arm is attached to the fish hook via a fishing line and as the arm moves in a direction away from the fish, the hook is set in the fish's mouth.

An embodiment of a fish hook system according to the present invention includes a sleeve extending between a sleeve first end and a sleeve second end, the sleeve second end including a base member. A plunger assembly is at least partially disposed and translatable within the sleeve. The plunger assembly includes a rod and an arm pivotally coupled to the rod within the sleeve. A trigger finger is rotatably attached to the base member and releasably engageable with the arm. A biasing member is arranged within the sleeve between the rod and the base member. The biasing member may be configured to bias the rod towards the sleeve first end.

According to one aspect of a fish hook system according to the present invention, the rod has a rod first end and a rod second end, the rod second end supporting an annular collar surface, and the biasing member is arranged between the base member and the annular collar surface.

According to another aspect of a fish hook system according to the present invention, the rod may further include a rod first end and a rod second end, and the arm comprises an arm proximal end (which is preferably pivotally coupled to the rod second end) and an arm distal end, the arm distal end having an offset bulb formed thereon. The trigger finger may include a pocket, which is configured to receive the offset bulb of the arm. The rod first end may protrude from the sleeve first end and the rod second end may be disposed within the sleeve.

According to still another aspect of a fish hook system according to the present invention, the trigger finger may include a finger proximal end and a free finger distal end, the finger proximal end being rotatably attached to the base, the finger being rotatable from a first stationary position substantially perpendicular to the sleeve to a second stationary position disposed at an acute angle with respect to the first stationary position. The trigger finger is configured to secure the bulb within the pocket when the finger is in the first stationary position and to release the bulb from the pocket when the finger is in the second stationary position.

### BRIEF DESCRIPTION OF THE DRAWINGS

FIG. 1 is a perspective view of a hook setting device according to the present invention.

FIG. 2 is a cut-away view along line 2-2 of FIG. 1.

FIG. 3 is an exploded view of the hook setting device of FIG. 1.

FIG. 4A is close-up partial cut-away view of the hook setting device shown in FIG. 1.

FIG. 4B is a close-up partial cut-away view of the hook setting device shown in FIG. 1.

FIGS. 5A-9C are views of the hook setting device according to the present invention of claim 1 in use.

FIG. 10A is a first partial cut-away view of a second embodiment of a hook setting device according to the present invention.

FIG. 10B is a second partial cut-away view of the embodiment of FIG. 10A.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

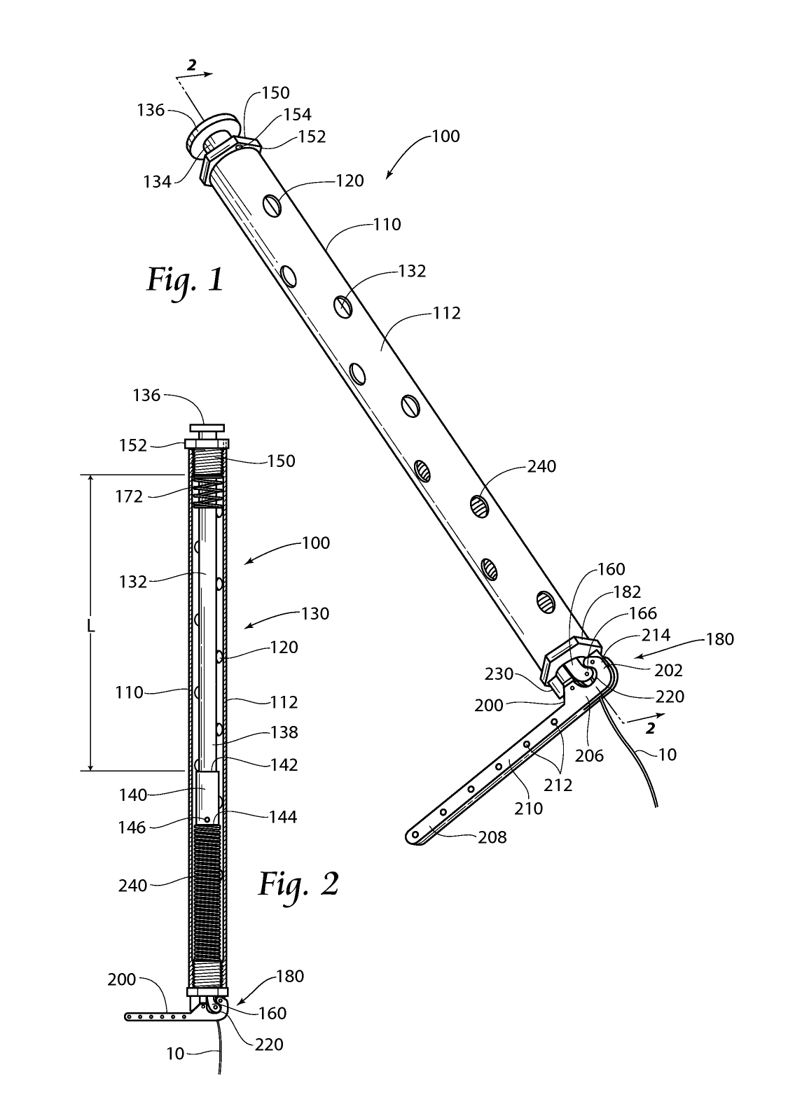

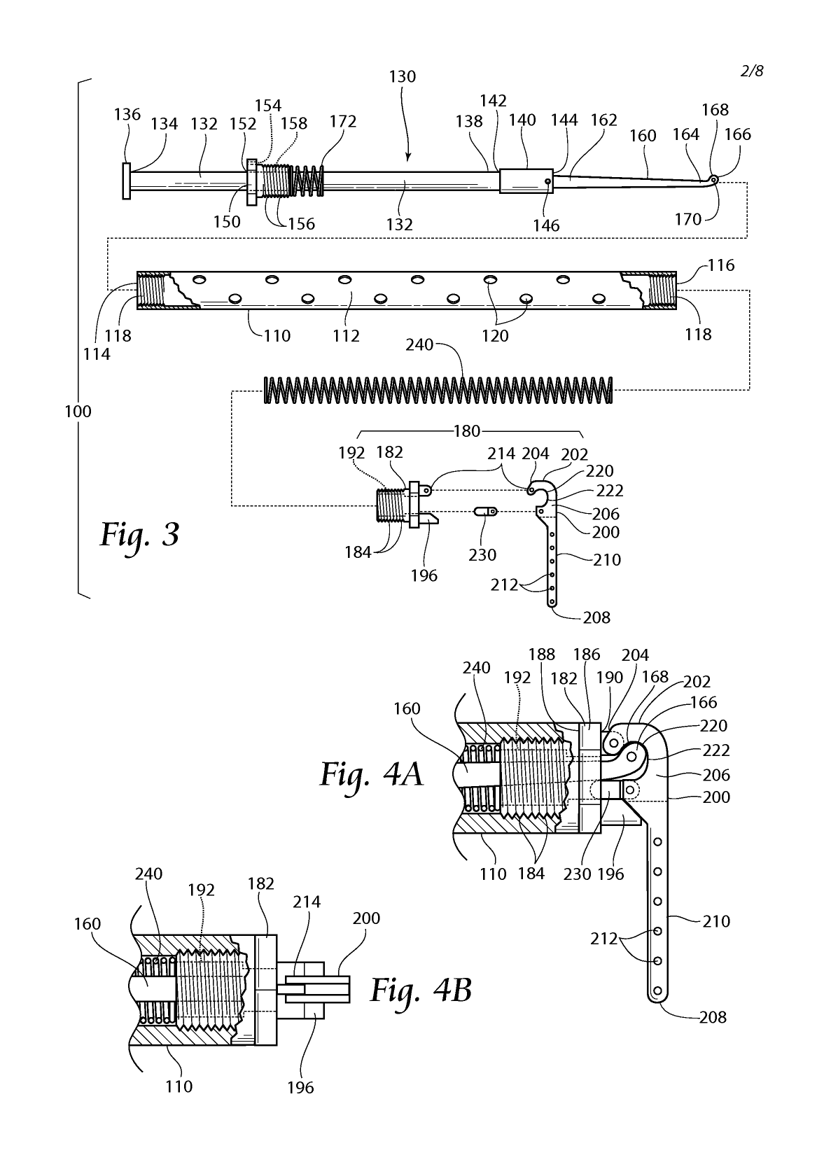

A first embodiment 100 of a hook setting device is shown in FIG. 1. The hook setting device 100 comprises a sleeve 110, a plunger assembly 130 (see FIG. 2), an activation member assembly 180, and a biasing member 240 (see also FIG. 2).

The sleeve 110 preferably comprises a tubular pipe 112 with a plurality of sleeve apertures 120. The pipe 112 has a pipe first end 114 and a pipe second end 116 opposite the pipe first end 114. The sleeve apertures 120 decrease the overall weight of the pipe 112 and allow fluid that may have entered the hook setting device 100 when submerged to exit upon activation of the hook setting device 100. The sleeve apertures 120 also allow air that may be trapped within the hook setting device 100 when submerged, potentially making the hook setting device 100 buoyant, to exit the hook setting device 100. The sleeve apertures 120 may take any shape including, but not limited to, circles and/or slots.

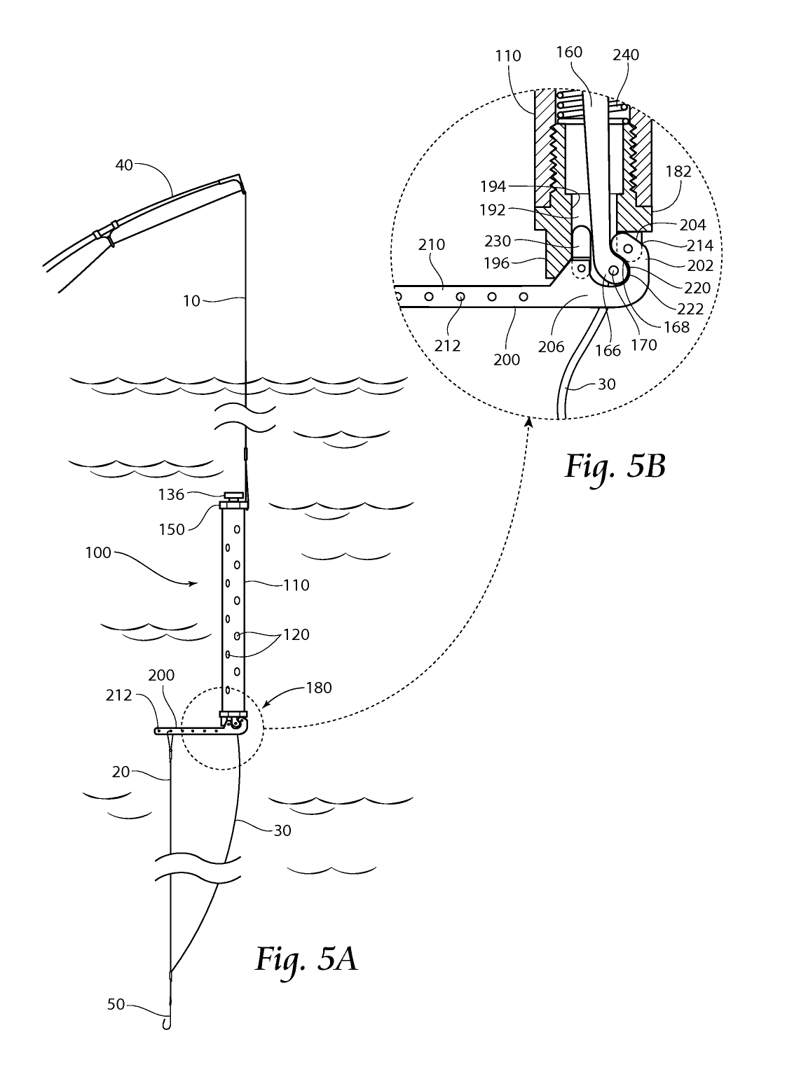

Turning now to FIGS. 2 and 3 in which the hook setting device 100 is shown in greater detail. FIG. 2 is a cut-away view of the hook setting device 100 according to the present invention and illustrates the otherwise interrelationships of the sleeve 110, the plunger assembly 130, and the activation member assembly 180. FIG. 3 illustrates an exploded view of the hook setting device 100 to better illustrate the specific elements of the hook setting device 100.

The partial cut-away view of the sleeve 110 in FIG. 3 illustrates pipe internal threads 118 extending inward from both the pipe first end 114 and the pipe second end 116.

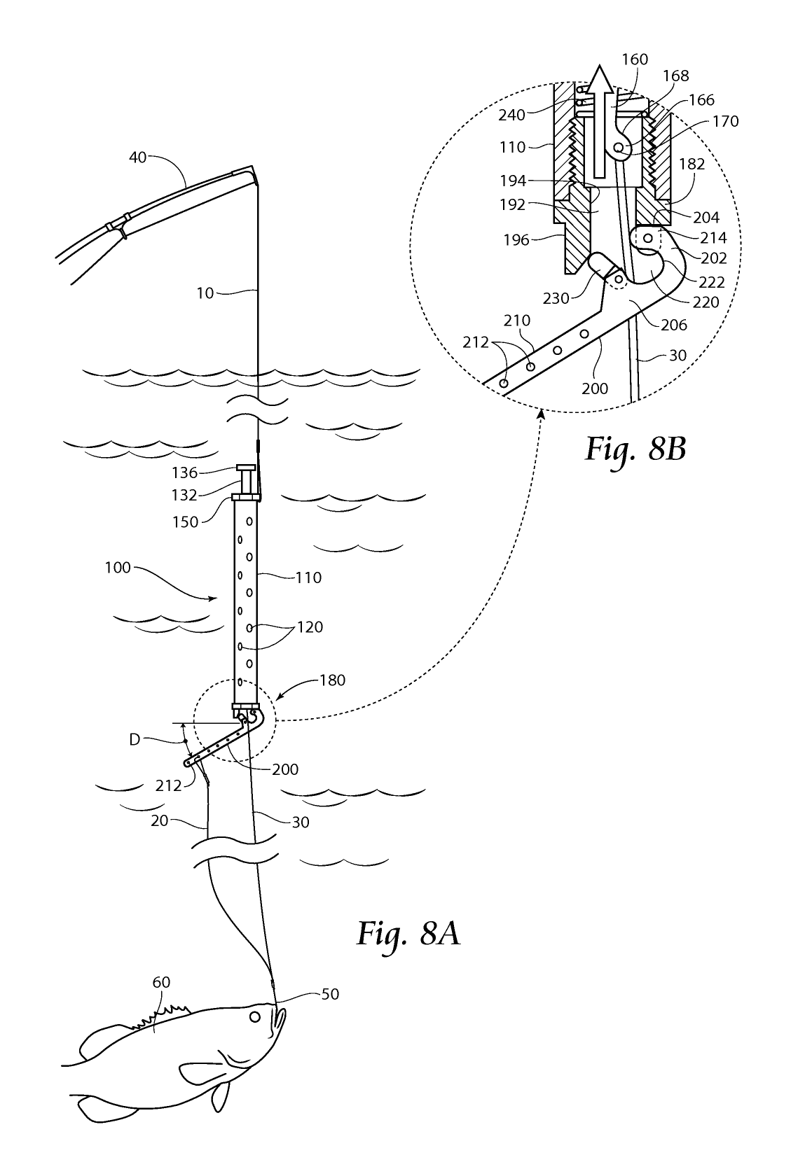

The activation member assembly 180 comprises a base 182, a finger 200, a knuckle 214, a pocket 220 defining a pocket surface 222, and a stopper 230. The base 182 comprises base external threads 184, a base collar 186 having an inwardly facing surface 188 and an outwardly facing surface 190, a base bore 192 defining a base bore surface 194 (see FIG. 5B), and a cantilever 196. The base external threads 184 interface with the pipe internal threads 118 of the pipe second end 116.

The finger 200 preferably comprises a finger proximal end 202, a finger medial portion 206, and a finger distal end 208. The finger proximal end 202 is rotatably attached to the base 182 at the knuckle 214. The stopper 230 is rotatably attached to the finger medial portion 206 and may extend into the base bore 192 and positioned alongside the cantilever 196. The finger 200 extends from the finger medial portion 206 to the finger distal end 208 forming a finger lever 210. The finger lever 210 preferably comprises a plurality of holes 212.

The plunger assembly 130 as shown here preferably comprises a rod 132, a fitting 150, and an arm 160. The rod 132 has a rod first end 134 with a rod first end collar 136 and a rod second end 138 with a rod second end collar 140. The rod second end collar 140 has a rod second end collar first surface 142 and a rod second end collar second surface 144. The arm 160 comprises an arm proximal end 162 and an arm distal end 164. The arm proximal end 162 is pivotally attached to the rod second end 138. Shown here, the arm proximal end 162 is pivotally affixed to the rod second end collar second surface 144 by pin 146. The arm distal end 164 terminates in an offset bulb 166. The offset bulb 166 comprises a catch surface 168 and a bulb aperture 170 extending through the offset bulb 166.

The fitting 150 comprises a fitting collar 152 with a collar through-hole 154, fitting external threads 156 and a fitting bore 158. The rod 132 is positioned through the fitting bore 158 and the fitting external threads 156 interface with the pipe internal threads 118 of the pipe first end 114.

Additionally or alternatively, a dampener 172, shown here as a coil spring, may be included between the fitting 150 and the rod second end collar first surface 142.

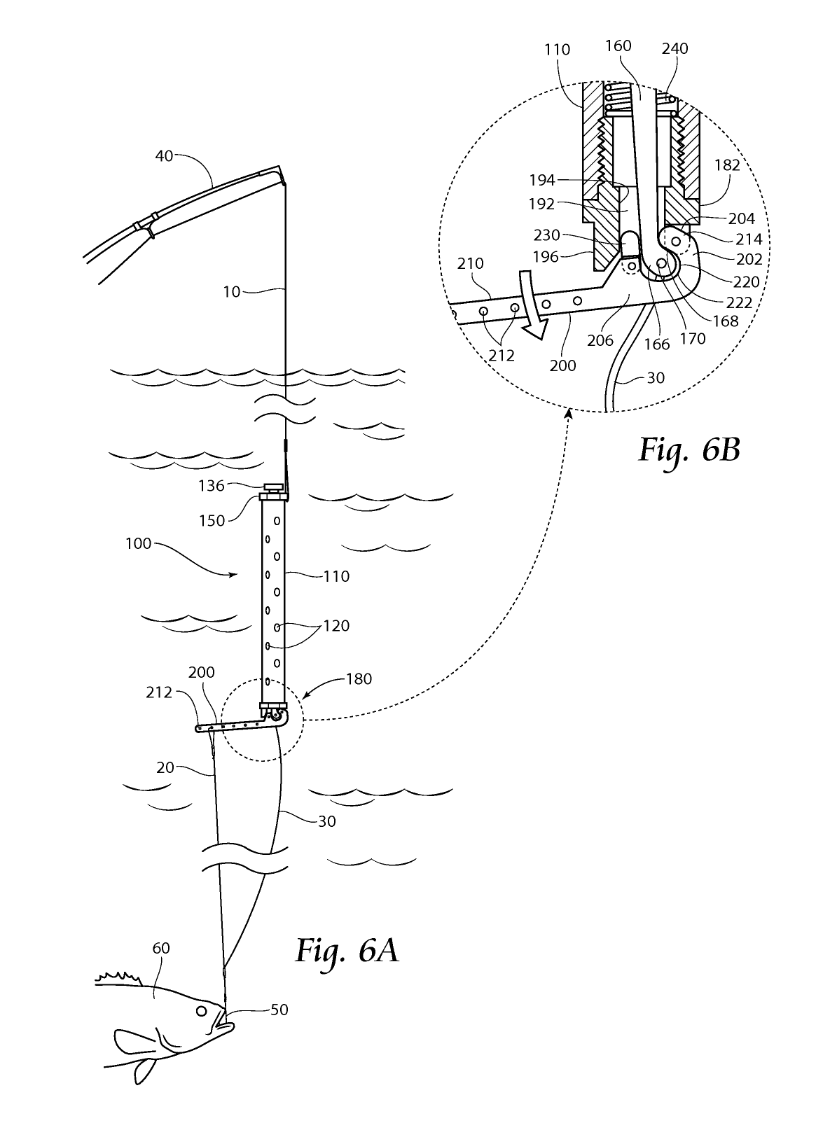

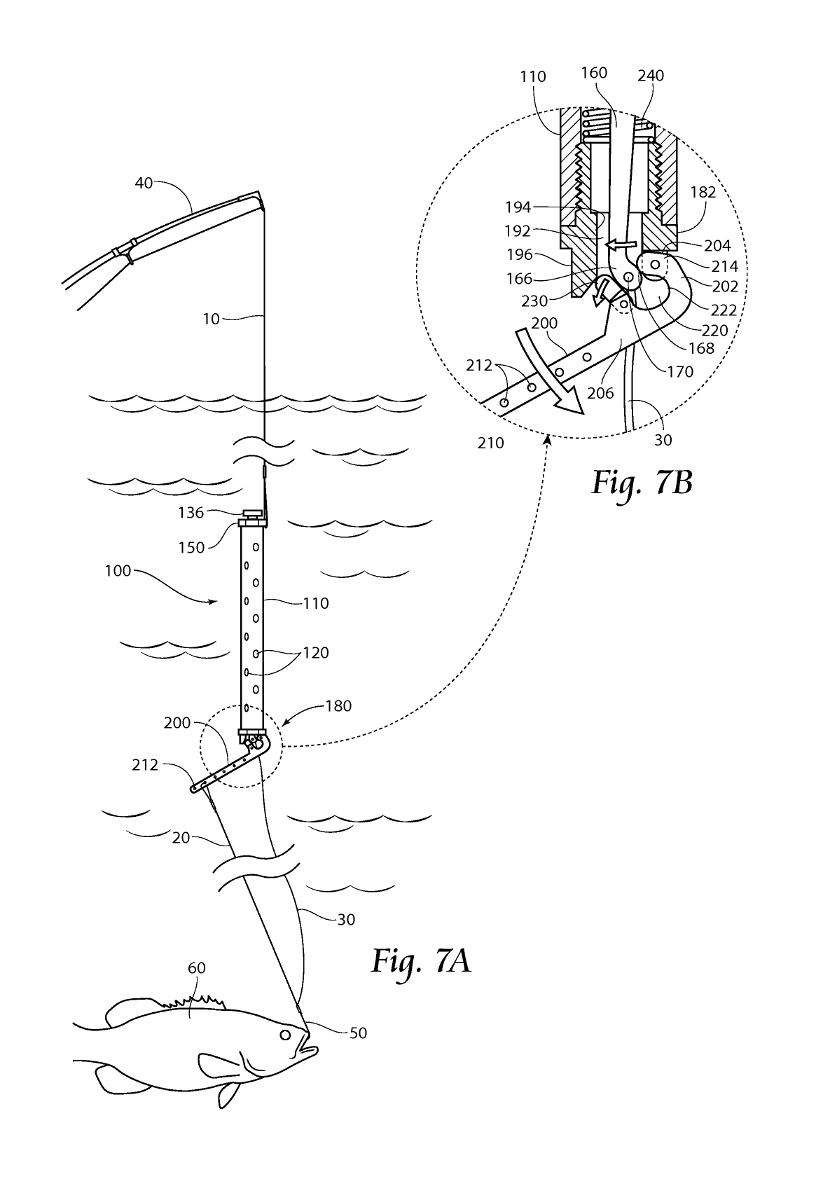

FIG. 4A shows the hook setting device 100 in an engaged state with the offset bulb 166 of the arm 160 within the pocket 220 of the activation member assembly 180. In the engaged state, the offset bulb 166 of the arm 160 is positioned within the pocket 220 and the stopper 230 is between the arm 160 and the base bore surface 194.

To place the hook setting device 100 into the engaged state, the finger lever 210 is rotated away from the sleeve 110, thus removing the stopper 230 from the base bore 192 (see FIG. 7B). Preferably, the periphery 204 of the finger proximal end 202 is shaped to provide an interference between the finger proximal end 202 and the outwardly facing surface 190 of the base collar 186, thus limiting rotation of the finger 200 past a predetermined angle and preferably before the stopper 230 travels completely beyond the cantilever 196.

The bulb 166 of the arm 160 may then be passed through the base bore 192 and into the pocket 220. The biasing member 240 is compressed during this transition as it is located between the base 182 and the rod second end collar second surface 144, thus inducing a compression spring force opposing the movement of the rod second end collar 140 towards the second end 116 of the pipe 112. In order to retain the bulb 166 within the pocket 220, the finger lever 210 is rotated back towards the sleeve 110 and the stopper 230 guides the arm 160 into a position in which the catch surface 168 of the bulb 166 abuts the pocket surface 222. Thus, the stopper 230 forces the arm 160 to interface the pocket surface 222 and the catch surface 168 to prevent the arm 160 from movement encouraged by the compressed biasing member 240.

FIG. 4B further illustrates the knuckle 214 and the cantilever as viewed from above the orientation of the hook setting device 100 in FIG. 4A.

FIGS. 5A-9B illustrate the operation of the hook setting device 100 according to the present invention. FIGS. 5A and 5B show the hook setting device 100 in the engaged position as described earlier with respect to FIGS. 4A and 4B. It can be seen that the offset bulb 166 is positioned within the pocket 220 and the stopper 230 is between the arm 160 and the base bore surface 194.

As shown in FIG. 5A, a first fishing line 10 extends from a fishing pole 40 to the pipe first end 114, on which the first fishing line 10 is secured through the collar through-hole 154. A second fishing line, or leader, 20 is secured on one end to one of the plurality of lever holes 212 and is secured to a fishing lure, here a hook 50, on the other end. A third fishing line, or leader, 30 is secured to the bulb aperture 170 and is tied in with the second fishing line 20, or lure 50, in a manner known to one skilled in the art. It should be noted that the first fishing line 10 may be attached to a BEAVER DAM TIP-UP® or any other fishing device, and the hook 50 may be of any type including, but not limited to, an EAGLE CLAW hook and NORTHLAND FISHING TACKLE® jigging lures.

The third fishing line 30 is preferably longer than the second fishing line 20. Briefly looking to FIG. 8A, it is preferred that the third fishing line 30 have a minimum additional length approximately greater than the combined distance traveled D of the finger lever 210, at the moment of activation of the hook setting device 100 and the length of the second fishing line 20 between the selected lever hole 212 and the connection point of the second fishing line 20 and the third fishing line 30. The distance D will be variable as it depends on which of the plurality of lever holes 212 is chosen.

It is also preferred that the third fishing line 30 have a maximum additional length longer than the second fishing line 20 approximately substantially less than the distance L (see FIG. 2) between the fitting 150 and the rod second end collar first surface 142 when the hook setting device 100 is in the engaged state.

In FIGS. 6A and 6B, a fish 60 approaches and bites the hook 50. The second fishing line 20 is pulled tight as the finger lever 210 rotates about the knuckle 214. The plurality of lever holes 212 allow an angler to set the amount of force needed for a fish 60 to release the plunger assembly 130. If less force is preferred, the angler may attach the second fishing line 20 in one of the plurality of lever holes 212 farther away from the knuckle 214. If more force is preferred, the angler may attach the second fishing line 20 in one of the plurality of lever holes 212 closer to the knuckle 214.

Looking now to FIGS. 7A and 7B, the fish 60 has rotated the finger lever 210 farther thus pulling the stopper 230 out of the base bore 192 and allowing the offset bulb 166 to exit the pocket 220.

In FIGS. 8A and 8B, the offset bulb 166 is completely out of the pocket 220 and the spring force induced by the compressed biasing member 240 is released, pulling the third fishing line 30 tight and setting the hook 50 in the fish 60.

As shown in FIGS. 9A-9C, the rod 132 travels through the sleeve 110 until the rod second end collar first surface 142 makes contact with the fitting 150 or dampener 172. In the embodiment shown, a dampener 172 is employed as alternatively described above with respect to FIGS. 2 and 3, allowing the rod 132 to be brought to a stop in a more controlled fashion.

It is further contemplated by the present invention that the hook setting device 100 may comprise different sizes for various size fish 60.

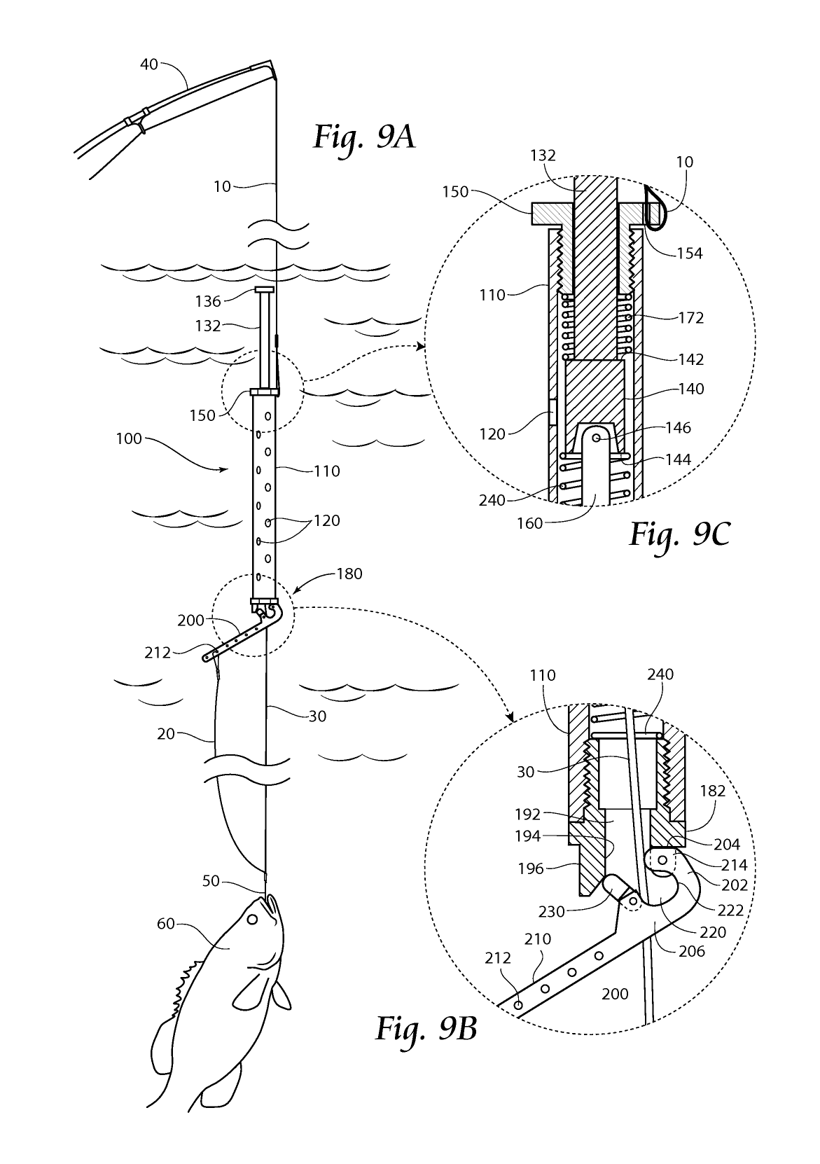

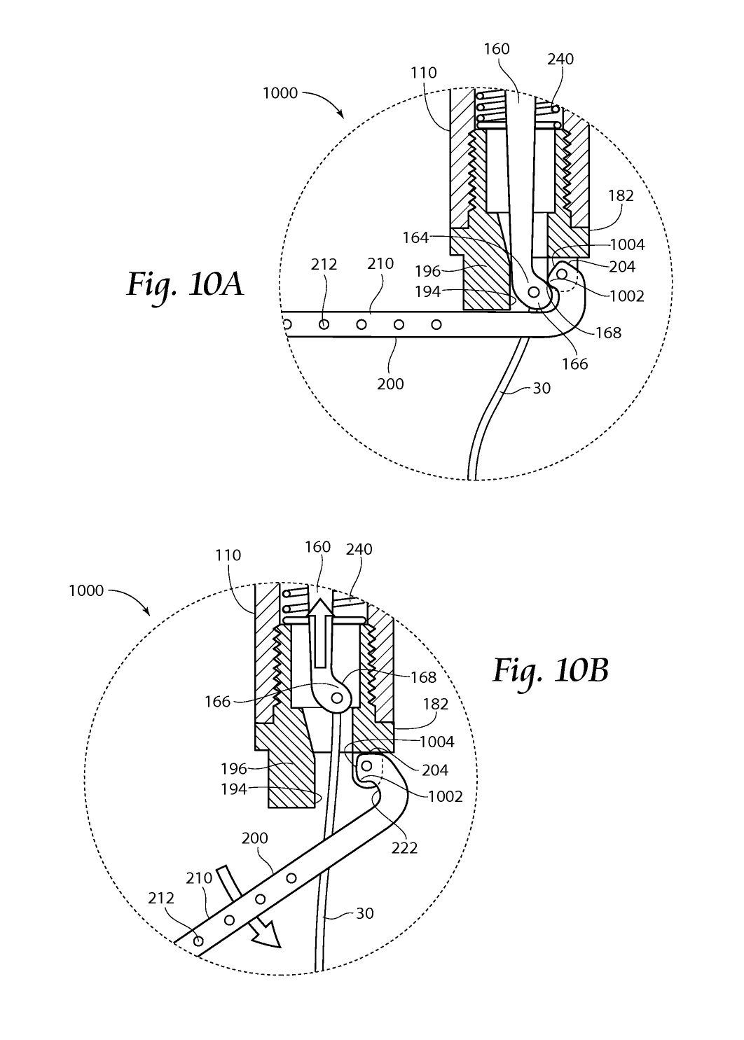

FIGS. 10A and 10B illustrate a second embodiment 1000 of the hook setting device. Here, the arm distal end 164 abuts the cantilever 196 and the offset bulb catch surface 168 is in contact with the pocket surface 222. The finger proximal end periphery 204 has a lobe-like profile 1002 with a flat spot 1004. According to this embodiment, when a fish 60 (as shown in FIG. 6A) triggers the hook setting device 1000, the finger 200 rotates relative to the arm offset bulb 166, and due to the lobe-like profile 1002 of the proximal end periphery 204, the flat spot 1004 will rotate to a position substantially alongside the offset bulb 166, thus releasing the arm 160. As the arm 160 would not necessarily need to pivot out of the pocket 220 according to this embodiment, the rod 132 and the arm 160 may be formed from one piece of material.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A fish hook system comprising:
a sleeve extending between a sleeve first end and a sleeve second end, the sleeve second end including a base member;
a plunger assembly disposed and translatable within the sleeve, the plunger assembly comprising:
a rod; and
an arm pivotally coupled to the rod within the sleeve;
a finger rotatably attached to the base member and releasably engageable with the arm; and
a biasing member arranged within the sleeve between the rod and the base member.

2. The fish hook system of claim 1, wherein the biasing member is configured to bias the rod towards the sleeve first end.

3. The fish hook system of claim 1, wherein the plunger assembly is disposed at least partially within the sleeve.

4. The fish hook system of claim 1, wherein the rod has a rod first end and a rod second end, the fish hook system further comprises an annular collar surface, the rod second end supports the annular collar surface, and the biasing member is arranged between the base member and the annular collar surface.

5. The fish hook system of claim 1, wherein
the rod further comprises a rod first end and a rod second end;
the arm further comprises an arm proximal end and an arm distal end, the arm distal end having an offset bulb formed thereon;
the finger further comprises a pocket;
the arm proximal end is pivotally coupled to the rod second end; and
the pocket is configured to receive the offset bulb of the arm.

6. The fish hook system of claim 5, wherein the rod first end protrudes from the sleeve first end and the rod second end is disposed within the sleeve.

7. The fish hook system of claim 5, wherein the finger further comprises a finger proximal end and a free finger distal end, the finger proximal end being rotatably attached to the base, the finger being rotatable from a first stationary position substantially perpendicular to the sleeve to a second stationary position disposed at an acute angle with respect to the first stationary position.

8. The fish hook system of claim 7, wherein the finger is configured to secure the bulb within the pocket when the finger is in the first stationary position and to release the bulb from the pocket when the finger is in the second stationary position.
